(19) United States
(12) Patent Application Publication
(10) Pub. No.: US 2013/0039641 A1
(43) Pub. Date: Feb. 14, 2013

(54) APERTURE DEVICE AND OPTICAL INSTRUMENT

(71) Applicant: SEIKO PRECISION INC., Narashino-shi (JP)

(72) Inventor: Hisashi KAWAMOTO, Narashino-shi (JP)

(73) Assignee: SEIKO PRECISION INC., Narashino-shi (JP)

(21) Appl. No.: 13/655,888

(22) Filed: Oct. 19, 2012

Related U.S. Application Data
(63) Continuation of application No. PCT/JP2011/071645, filed on Sep. 22, 2011.

(30) Foreign Application Priority Data
Jan. 7, 2011 (JP) 2011-002463

(51) Int. Cl. G03B 9/02

(52) U.S. Cl. 396/508

(57) ABSTRACT

An aperture device includes: a board including an opening; a step motor capable of stopping every predetermined rotational angle; an output member including first and second pins and rotating a predetermined range by the step motor; and first and second blades driven by the output member with first and second blades respectively engaging with the first and second pins, linearly moving in opposite directions, and covering the opening to adjust an aperture area of the opening; wherein an X-axis indicates a phantom line passing through a rotational center of the output member and extending in the moving directions of the blades, and when the aperture area is a minimum, an angle between a directional line, which connects the rotational center with the first pin, and the X-axis is from minus 20 degrees to plus 30 degrees.

### CROSS-REFERENCE TO RELATED APPLICATION

This application is a continuation of and claims priority to International Patent Application No. PCT/JP2011/071645 filed on Sep. 22, 2011, which claims priority to Japanese Patent Application No. 2011-002463 filed on Jan. 7, 2011, subject matter of these patent documents is incorporated by reference herein in its entirety.

### BACKGROUND

(i) Technical Field

The present invention relates to aperture devices and optical instruments.

(ii) Related Art

There is known an aperture device employed in an optical instrument such as a camera. Such an aperture device includes blades which suitably cover an opening provided in a board and which adjust an area of the opening through which the light passes toward an imaging surface arranged the inside of the opening, that is, the blades adjust an aperture area. Japanese Unexamined Patent Application Publication No. 2-90132 discloses a technique relevant to such a device.

In a case where a step motor capable of stopping every predetermined rotational angle is employed as a drive source of the blades, the blades can stop at plural positions. Therefore, the aperture area can be adjusted.

In such an aperture device, the stop positions of the blades are set such that difference between Aperture values (hereinafter referred to as Av value) at the adjacent stop positions is equal. A moving amount of the blade for changing the Av value by an equal difference (hereinafter referred to as target moving amount) is set every stop positions of the blade on the basis of an initial position such as a position of the blade forming a minimum aperture. Herein, it is assumed that an interval moving amount means a distance between the adjacent stop positions of the blade. This interval moving amount changes depending on the Av value. Specifically, the interval moving amount decreases as an aperture area adjusted by the blades decreases, and the interval moving amount increases as the area of the opening adjusted by the blades increases. In other words, the interval moving amount decreases as the Av value increases, and the interval moving amount increases as the Av value decreases.

Thus, for example, it is supposed that the moving amount of the blade per an angle between the stop positions of the step motor (hereinafter referred to as unit moving amount) is substantially constant in the whole moving range of the blade. In this case, the unit moving amount relative to the interval moving amount increases as the area of the opening decreases. Also, the unit moving amount relative to the interval moving amount decreases as the area of the opening increases. Thus, the difference between an actual Av value and the target Av value might increase, due to a variation in the unit moving amount caused by the mechanical error or the like, as the aperture area decreases. This might make the moving amount of the blade rough so as not to satisfy the unit moving amount for ensuring a suitable exposure. In such a way, the accuracy of the aperture might be degraded.

### SUMMARY

It is thus an object of the present invention to provide an aperture device for improving the accuracy of the aperture and an optical instrument having the same.

According to an aspect of the present invention, there is provided an aperture device including: a board including an opening; a step motor capable of stopping every predetermined rotational angle; an output member including first and second pins and rotating a predetermined range by the step motor; and first and second blades driven by the output member with first and second blades respectively engaging with the first and second pins, linearly moving in opposite directions, and covering the opening to adjust an aperture area of the opening; wherein an X-axis indicates a phantom line passing through a rotational center of the output member and extending in the moving directions of the blades, a Y-axis indicates a phantom line passing through the rotational center of the output member and being perpendicular to the X-axis, and when the aperture area is a minimum, an angle between a directional line, which connects the rotational center with the first pin, and the X-axis is from minus 20 degrees to plus 30 degrees.

### BRIEF DESCRIPTION OF THE DRAWINGS

FIGS. 1A and 1B are perspective views of an aperture device according to an embodiment;

FIGS. 2A and 2B are explanatory views of a drive mechanism;

FIGS. 3A to 3D are explanatory views of the operation of blades;

FIG. 4 is an explanatory view of a position of the blade when an aperture area is the minimum;

FIG. 5 is a graph of the relationship between an angle, between an X-axis and a directional line, and a moving amount of the blade in the X-axis direction;

FIG. 6A is an enlarged view around cam slots when the aperture area is the minimum, and FIGS. 6B and 6C are explanatory views of a correction method of the cam slots;

FIG. 7 is an explanatory view of a shape of the cam;

FIGS. 8A and 8B are explanatory views of the rotational angle range of the output member; and

FIGS. 9A and 9B are explanatory views of a reduction in size of the output member caused by a difference in the rotation angle range of the output member.

### DETAILED DESCRIPTION

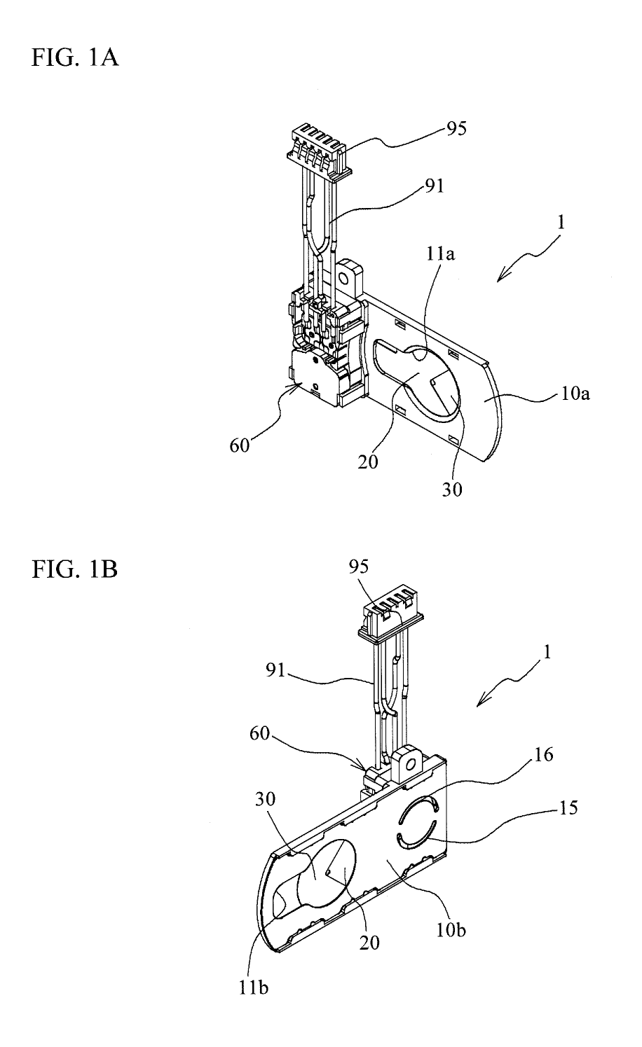

FIGS. 1A and 1B are perspective views of an aperture device 1 according to an embodiment. The aperture device 1 is employed in an optical instrument such as a camera. The aperture device 1 includes: boards 10a and 10b, blades 20 and 30, and a drive mechanism 60. The boards 10a and 10b are assembled to face each other. The blades 20 and 30 are movably arranged between the boards 10a and 10b. The boards 10a and 10b are respectively formed with openings 11a and 11b. The blades 20 and 30 linearly move in the opposite directions to overlap the openings 11a and 11b. This adjusts an aperture area of the openings 11a and 11b. The board 10a is provided with the drive mechanism 60 for driving the blades 20 and 30.

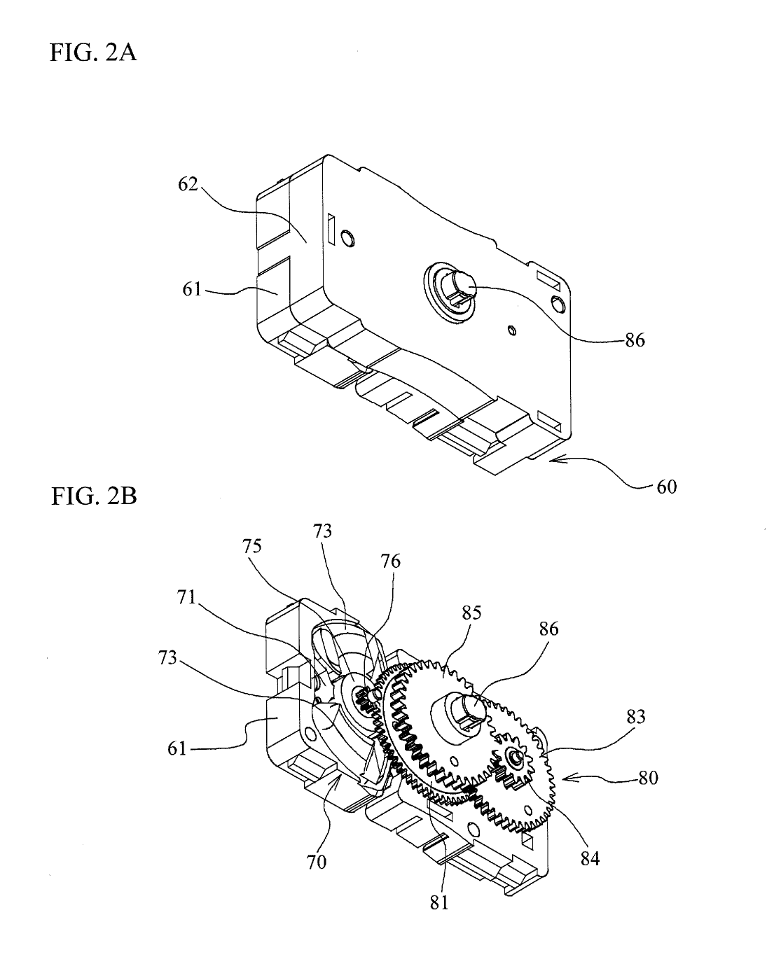

FIGS. 2A and 2B are explanatory views of the drive mechanism 60. The drive mechanism 60 includes cases 61 and 62 assembled into each other. An output shaft 86 protrudes from the case 62. FIG. 2B illustrates the drive mechanism 60 from which the case 62 is detached. As illustrated in FIG. 2B, a step motor 70 is arranged within the case 61. A speed reduction mechanism 80 is arranged within the case 62. The step motor 70 functions as a drive source for the blades 20 and 30. The speed reduction mechanism 80 functions to transmit the driving force of the step motor 70 to the blades 20 and 30.

The step motor 70 is a step motor which can stop every predetermined rotational angle. The step motor 70 includes: a stator 71 having a substantial U shape; two coils 73 wound around the stator 71 and energizing the stator 71; and a rotor 75 facing both ends of the stator 71 and rotatably supported by the case 61. The rotor 75 is magnetized to have different polarities in its circumstantial direction. Depending on energized states of the coils 73, both the ends of the stator 71 are excited to have different polarities, respectively. The rotor 75 is rotated in a predetermined angular range by the magnetic attractive force and the magnetic repulsive force generated between the both ends of the stator 71 and the rotor 75. Herein, the minimum of the rotational angle range of the rotor 75 is referred to as one step rotation. The step motor 70 rotates by one step on the basis of one drive pulse for energization at one time, that is, rotates in a specific rotational angle. A pinion gear 76 is fixed on the end of a rotational shaft of the rotor 75.

The ends of the coils 73 are electrically connected with cables 91 illustrated in FIGS. 1A and 1B. Also, a connector 95 is connected with the ends of the cables 91. The connector 95 is provided for being connected with a device installed within the optical instrument in which the aperture device 1 is installed. Specifically, the connector 95 is connected with a connector mounted on a printed circuit board arranged within the optical instrument. Thus, the energization states of the coils 73 are controlled by a control circuit formed in the printed circuit board. Therefore, the rotation of the step motor 70 is controlled, and the operation of the aperture device 1 is controlled.

The speed reduction mechanism 80 includes gears 81, 83, 84, and 85, and the output shaft 86. Although the gears 81 and 85 are coaxially arranged with each other, both of them are not connected with each other. That is, the gears 81 and 85 can rotate individually. The pinion gear 76 meshes with the gear 81. A gear, not illustrated, is provided between the gears 81 and 85. This gear is fixed in the gear 81 and then rotates together with the gear 81. This gear has a diameter smaller than the gear 81. This gear engages with the gear 83 which has a diameter larger than the diameter of this gear. The gear 84 which has a diameter smaller than the diameter of the gear 83 is fixed therein, and the gear 84 rotates together with the gear 83. The gear 84 engages with the gear 85 which has a diameter larger than the diameter of the gear 84. The output shaft 86 is provided in the gear 85. In such a way, the drive force from the drive mechanism 60 is decelerated and transmitted through the plural gears to the output shaft 86.

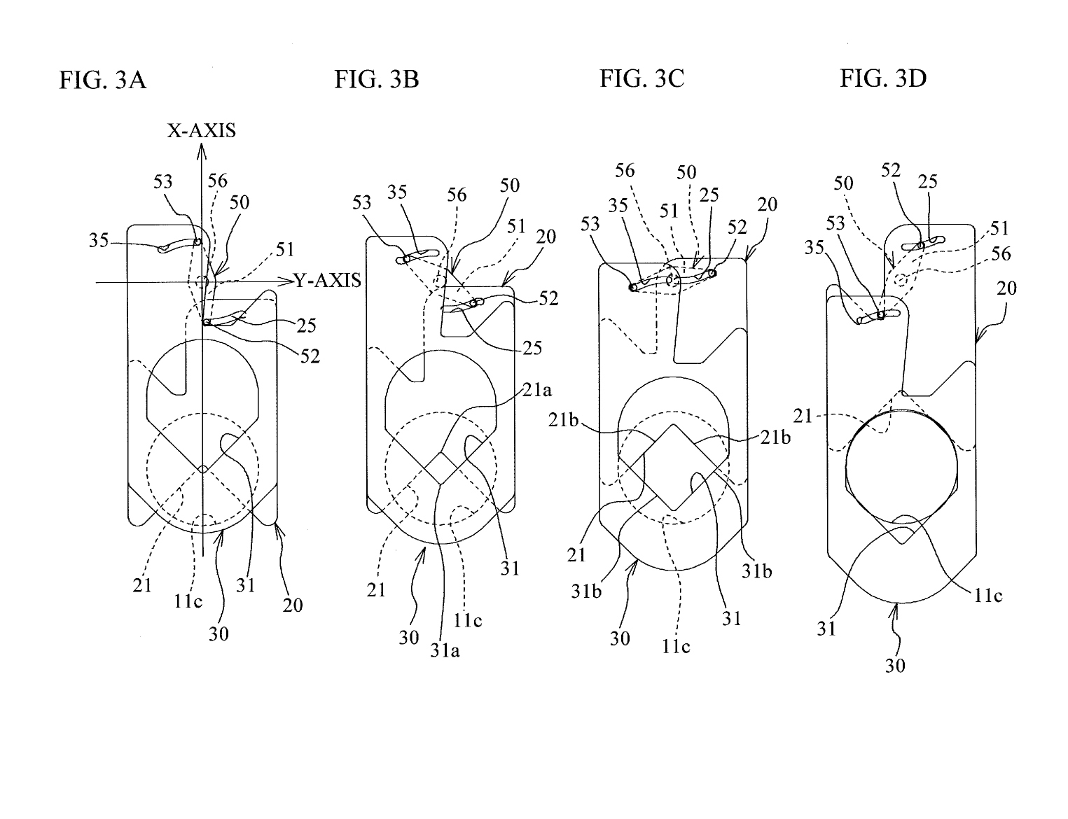

The operation of the blades 20 and 30 will be described. FIGS. 3A to 3D are explanatory views of the operation of the blades 20 and 30. The output member 50 is connected with the output shaft 86. The output member 50 engages with the blades 20 and 30, and drives the blades 20 and 30. The output member 50 functions to transmit the drive force of the drive mechanism 60 to the blades 20 and 30. The output member 50 is arranged between the boards 10a and 10b illustrated in FIGS. 1A and 1B.

The output member 50 includes: an arm portion 51 which extends in a predetermined direction; and pins 52 and 53 which are respectively provided at both ends of the arm portion 51. Also, the arm 51 is formed at its center with a hole 56 into which the output shaft 86 is fitted. The output member 50 rotates about the hole 56. The pins 52 and 53 respectively engage with a cam slot 25 of the blade 20 and a cam slot 35 of the blade 30. Additionally, as illustrated in FIG. 1B, the board 10b is formed with escape slots 15 and 16 which have arc shapes and which escape the pins 52 and 53, respectively. Additionally, likewise, the board 10a is formed with non-illustrated escape slots which function to restrict the rotation of the pins 52 and 53, respectively.

The blades 20 and 30 are formed with a cutout 21 and an opening 31, respectively. The blades 20 and 30 move along the X-axis, as will be described later, in the opposite directions. This changes an aperture shape of the opening having a substantially diamond shape sandwiched by the cutout 21 and the opening 31. On the basis of the manner of overlapping of the aperture shape and the opening 11c, an aperture area of the opening 11c is adjusted. Herein, the aperture area is an area, in the opening 11c, of the substantial opening which does not overlap the blades 20 and 30 and through which the light enters. Additionally, the opening 11c is defined by the openings 11a and 11b respectively formed in the boards 10a and 10b. The opening 11c has a circular shape.

As illustrated in FIGS. 3B and 3C, in order to respectively form arc shapes at opposite angle portions, on the X-axis, of the aperture shape having a substantially diamond shape, arc portions 21a and 31a are respectively provided at the cutout 21 and the opening 31. Opposite side portions 21b and 31b are provided at the cutout 21 and the opening 31 and extend in the tangential directions of the arc portions 21a and 31a, respectively.

As illustrated in FIG. 3A, the aperture area of the opening 11c is minimized by the cutout 21 and the opening 31. In this case, the amount of light passing through the opening 11c is the minimum. In general, images obtained by the aperture device 1 deteriorate, when the aperture diameter is too small. Herein, in the aperture device 1, the minimum aperture area means an aperture area corresponding to the smallest aperture diameter in which images standing up to use can be obtained. Alternatively, unlike the present embodiment in which the blades 20 and 30 do not fully close the opening 11c, in a mechanism in which the opening 11c can be fully closed, the minimum aperture area means the practically smallest aperture area in which images can be obtained. When the output member 50 rotates counterclockwise from the state illustrated in FIG. 3A, the aperture area of the opening 11c is adjusted to be large. FIG. 3B illustrates the state where the step motor 70 stops after rotating by given steps from the state illustrated in FIG. 3A. In FIG. 3B, the blades 20 and 30 and the output member 50 stop. FIG. 3C illustrates the state where the step motor 70 stops after further rotating by given steps from the state illustrated in FIG. 3B. In FIG. 3C, the blades 20 and 30 and the output member 50 stop. FIG. 3D illustrates the state where the step motor 70 stops after further rotating by given steps from the state illustrated in FIG. 3C. FIG. 3D illustrates the state where the aperture area of the opening 11c is the maximum. In the state illustrated in FIG. 3D, the blades 20 and 30 and the output member 50 also stop. Herein, when the aperture area of the opening 11c is the maximum, the opening 11c is in the fully opened state.

Additionally, FIGS. 3A to 3D illustrates four different stop positions of the blades 20 and 30. However, in the aperture device 1 according to the present embodiment, the blades 20 and 30 are stoppable at four or more different positions. That is, the aperture device 1 according to the present embodiment can adjust the aperture area of the opening 11c to four or more phases.

As illustrated in FIGS. 3A to 3D, a hole 65 corresponding to the rotational center of the output member 50 overlaps at least one of the blades 20 and 30 in any state. In general, a rotational angle of a rotor in a galvanometer, as will be described later, is limited to a predetermined range. However, a rotational angle of the rotor in the step motor is not limited. In the present embodiment employing the step motor 70, the rotational angle of the output member 50 can be properly set. Thus, in the moving ranges of the blades 20 and 30 linearly moving in the opposite directions, the hole 56 serving as the rotational center of the output member 50 tends to overlap a part of the blades 20 and 30 in a planar manner. Therefore, in the moving ranges of the blades 20 and 30, it is configured that the hole 56 serving as the rotational center of the output member 50 overlaps at least part of the blades 20 and 30. This makes it possible to ensure the large rotational angle range of the output member 50 by the step motor 70 without limitation. Also, the drive force of the step motor 70 is transmitted to the blades 20 and 30 through the speed reduction mechanism 80. It is thus possible to move and stop the blades 20 and 30 with large torque.

The aperture device 1 according to the present embodiment employs the step motor 70, so the blades 20 and 30 can be stopped at plural positions in the moving ranges. Therefore, the aperture area of the opening 11c can be set to a desired size.

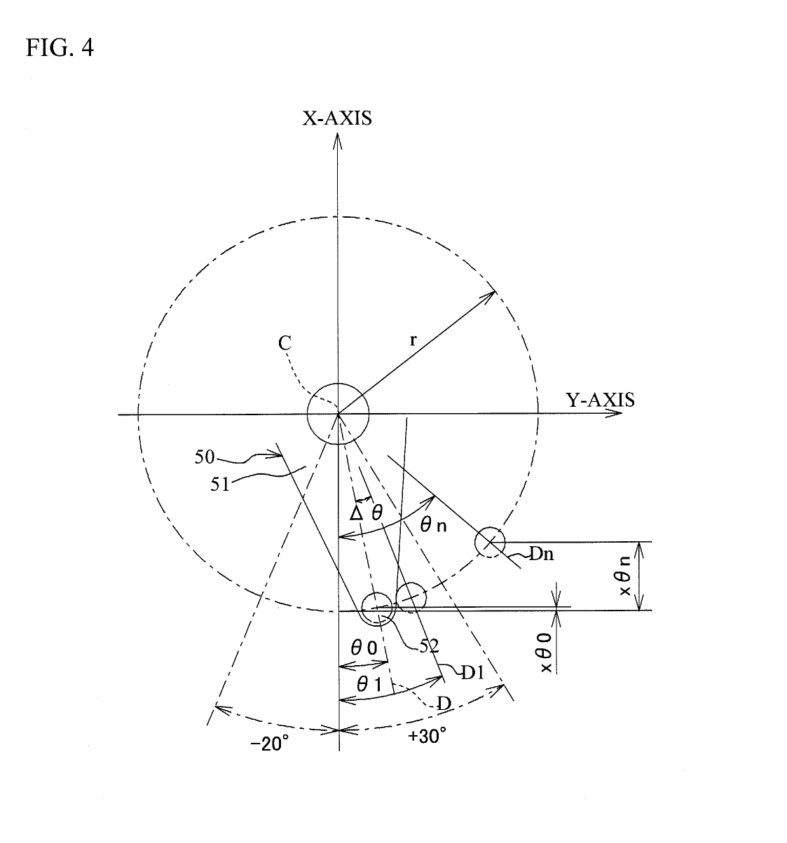

A description will be given of the position of the output member 50 when the aperture area of the opening 11c is the minimum. FIG. 4 is an explanatory view of the position of the output member 50 when the aperture area of the opening 11c is the minimum. FIG. 4 illustrates an X-axis and a Y-axis passing the rotational center C of the arm portion 51. The X-axis indicates a virtual line passing through the rotational center C of the arm portion 51 and extending in the moving directions of the blades 20 and 30. The Y-axis indicates a virtual line passing through the rotational center C of the arm portion 51 and being perpendicular to the X-axis. A directional line D is a line connecting the rotational center C with the pin 52. The directional line D indicates the direction in which the output member 50 extends.

When the aperture area of the opening 11c is the minimum, an angle θ0 between the directional line D and the X-axis is set from minus 20 degrees to plus 30 degrees. That is, the angle θ0 may be minus 20 degrees or plus 30 degrees. In the example illustrated in FIG. 4, the angle θ0 is set from 0 degrees to plus 30 degrees. The reason why the angle range is set will be described below.

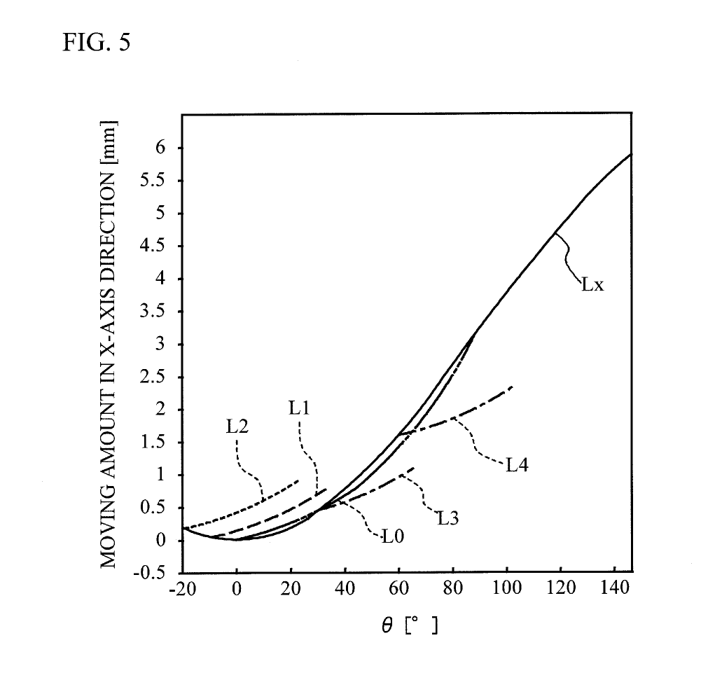

FIG. 5 is a graph indicating the relationship between the angle θ, between the X-axis and the directional line D, and the moving amount of the blade 20 in the X-axis direction. Additionally, this graph indicates an example in which the moving amount of the blade 20 in the X-axis direction is zero when θ is 0 degrees and the distance between the rotational center C and the pin 52 is 3.2 mm. A curve Lx indicates the moving amount of the blade 20 in a case where it is assumed that the cam slot 25 engaging with the pin 52 is a virtual cam slot Y′ having a linear shape parallel with the Y-axis. As for the curve Lx, the moving amount in the X-axis direction per angle increases as θ increases from 0 degrees to 90 degrees. The moving amount in the X-axis direction per angle decreases as θ increases from 90 degrees to 180 degrees. Additionally, the real shape of the cam slot 25 is not linear shape and is corrected, as will be described in detail later.

Herein, L0 to L4 indicate the moving amount of the blade 20 in the X-axis direction in a case where the Av value, defined by the aperture area of the opening 11c since the output member 50 starts rotating, changes by an equal difference with respect to the rotational angle θ of the output member 50, that is, with respect to the number of the drive pulses of the step motor 70. Additionally, in the following description, changing the Av value by an equal difference simply means changing the Av value with respect to the rotational angle θ of the output member 50, that is, with respect to the number of the drive pulses of the step motor 70. Here, L0, L1, L2, L3, and L4 indicate cases where the output member 50 starts rotating from the position in which θ is 0 degrees, minus 10 degrees, minus 20 degrees, plus 30 degrees, and plus 60 degrees, respectively. Also, L0 indicates the moving amount of the blade 20 in the X-axis direction in a case where the Av value defined by the aperture area of the opening 11c changes by an equal difference with respect to the number of the drive pulses of the step motor 70, in the range where the output member 50 rotates from the position in which θ is 0 degrees to the position in which θ is 90 degrees, that is, in the range of the small aperture side where the pin 52 of the output member 50 rotates to reach the Y-axis indicating that θ is 90 degrees.

Any angles of inclination of L0 to L4 increase as the angle increases. That is, as for L0 to L4, the moving amount of the blade per angle increases as the angle increases. This is because the target moving amount of the blade 20 for changing the Av value by an equal difference changes based on the Av value. Specifically, the interval moving amount decreases as the aperture area adjusted by the blade 20 decreases, and the interval moving amount increases as the aperture area adjusted by the blade 20 increase. In other words, the interval moving amount decreases as the Av value increases, and the interval moving amount increases as Av value decreases. Thus, it is desired that the moving amount of the blade 20 is small in the vicinity of the position in which the aperture area of the opening 11c is the minimum.

As illustrated in FIG. 5, a difference between L4 and Lx is comparatively great. However, a difference between any one of L0 to L3 and Lx is comparatively small. In such a way, the position in which the output member 50 starts rotating is set from minus 20 degrees to plus 30 degrees, thereby making the actual moving amount of the blade 20 close to the moving amount achieving the target Av value. This improves the accuracy of the aperture.

Also, the curve Lx is described above as an example of the virtual cam slot Y′ formed on a straight line parallel with the Y-axis. For this reason, even if the rotation start position of the output member 50 is set from minus 20 degrees to plus 30 degrees, there is the difference between the moving amount indicated by the curve Lx and the actual moving amount of the blade 20. Thus, in the present embodiment, the shape of the cam slot 25 is corrected to include a region. The region can move the blade 20 as to change the Av value by an equal difference, the Av value being defined by the aperture area of the opening 11c, in the range of the small aperture side between the position in which the output member 50 starts rotating and the position in which the output member 50 reaches the Y-axis indicating that θ is 90 degrees. Additionally, the shape of the cam slot 25 has only to include a region which can move the blade 20 to change the Av value by an equal difference, the Av value being defined by the aperture area of the opening 11c.

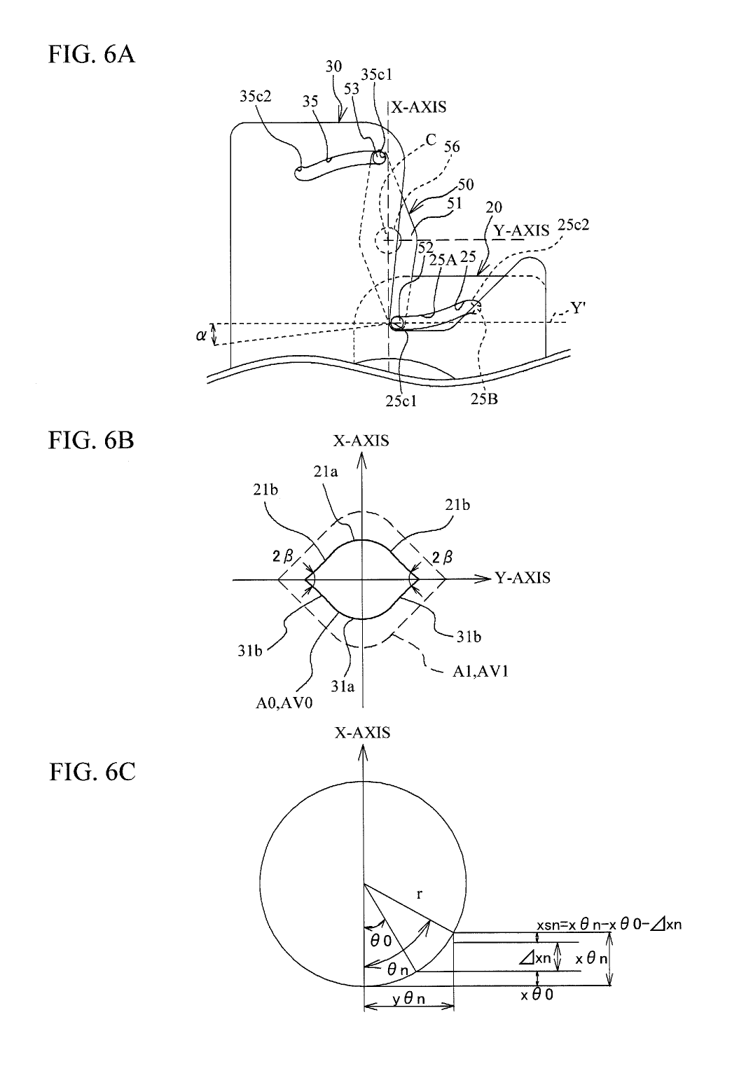

Herein, a method of correcting the cam slot 25 will be described with reference to FIGS. 4 and 6A to 6C. In FIG. 4, θ0 stands for an angle between the X-axis and the directional line D connecting the rotational center C of the output member 50 with the pin 52 when the aperture area of the opening 11c is the minimum. D1 stands for a directional line connecting the rotational center C with the pin 52 when an adjacent Av value is achieved by further rotating the output member 50 counterclockwise in such a direction as to increase the aperture area. θ stands for an angle between the directional line D1 and the X-axis. Likewise, a single step stands for an interval between adjacent Av values in such a direction as to increase the aperture area. Dn stands for a directional line connecting the rotational center C and the pin 52 when rotation is performed by n steps. θn stands for an angle between the directional line Dn and the X-axis. Also, r stands for a distance between the rotational center C and the pin 52. A unit rotational angle stands for a predetermined rotational angle of the output member 50 for changing a specific Av value into an adjacent Av value. A unit rotational angle Δθ stands for an angle for changing the Av value in the aperture area minimum state into an adjacent Av value, and Δθ=θ1−θ0 is satisfied. Under conditions where the X-axis coordinate of the pin 52 is zero when θ is 0 degrees, the X-axis coordinate xθ0 of the pin 52 is expressed by the following equation 1 when θ0 is established.

[Equation 1]

xθO=r(1−cos θ0) (1)

Likewise, the X-axis coordinate of the pin 52 is expressed by the following equation 2 when θn is established. These expressions also indicate the position of the blade 20 in the X-axis direction when the phantom cam slot Y′ formed on a straight line parallel with the Y-axis is used.

[Equation 2]

xθn=r(1−cos θn) (2)

FIG. 6A is an enlarged view around the cam slot 25 when the aperture area of the opening 11c is the minimum. In FIG. 6A, the cam slot 25 is not parallel with the Y-axis and is slightly curved in order to change the Av value by an equal difference with respect to the number of the drive pulses of the step motor 70, the Av value being defined by the aperture area of the opening 11c. FIG. 6B is an enlarged view of the opening shape overlapping the opening 11c. In FIG. 6B, A0 indicates the aperture area at the minimum, AV0 indicates an Av value at this time, and the aperture shape is illustrated by a solid line. A1 indicates the aperture area when the adjacent Av value is established to increase the aperture area, AV1 indicates an Av value at this time, and the aperture shape is illustrated by a broken line. FIG. 6B illustrates a change in the aperture shape when the output member 50 rotates counterclockwise to θ1 from θ0 illustrated in FIG. 4. Herein, ΔAv indicates an interval between the adjacent Av values to be changed as considering the specification of the aperture device, and AV1 is calculated by the expression: AV1=AV0−ΔAv. Also, the aperture area A1 at this time is calculated by the expression: A1=A0×2^{(AV0-AV1)}, and the position of the blade 20 in the X-axis direction is determined to satisfy this area. Specifically, in FIG. 6B, R stands for each radius of the arc portions 21a and 31a, and 2β (rad) stands for an interior angle of the end in the Y-axis direction. In other words, when β stands for an angle between the Y axis and each of the opposite side portions 21b and 31b, A0=2R²(1/tan β+β) is established. Under conditions where A(n−1) stands for an aperture area and AV(n−1) stands for an Av value when the rotation is performed by n−1 steps, An standing for an aperture area when the rotation is performed by n steps, that is, when the rotation to θn is performed is expressed by the following equation (3).

[Equation 3]

An=Λ(n−1)×2^{(AV(n-1)-AVn)}A0×2^{(AV0-AVn)} (3)

where n is an integer equal to or greater than one.

In FIG. 6C, 0 indicates the X-axis coordinate of the pin 52 when θ is 0 degrees, xθ0 indicates the X-axis coordinate of the pin 52 when θ0 is established, and xθn indicates the X-axis coordinate of the pin 52 when θn is established. Δxn indicates a moving amount of the blade 20 in the X-axis direction in order to change A0 into An, that is, Δxn indicates a target moving amount. The correction amount xsn of the cam slot 25 in the X-axis direction when θn is established is expressed by the following expression (4).

[Equation 4]

xsn=xθn−xθ0−Δxn (4)

Here, a moving amount Δxn of the blade 20 in the X-axis direction in order to change A0 into An is expressed by the following equation (5).

$$\begin{matrix}[ Equation 5 ] & \\ Δ x n = \frac{- R}{cos β} + \frac{1}{cos β} \sqrt{( {R}^{2} - \frac{( A 0 - An ) sin β cos β}{2} )} & ( 5 )\end{matrix}$$

Thus, the correction amount xsn of the cam slot 25 in the X-axis direction when θn is established is expressed by the following equation (6) using θ0, θn, r, R, β, A0, and An.

$$\begin{matrix}[ Equation 6 ] & \\ x s n = r ( cos θ0 - cos θ n ) + \frac{R}{cos β} - \frac{1}{cos β} \sqrt{( {R}^{2} - \frac{( A 0 - An ) sin β cos β}{2} )} & ( 6 )\end{matrix}$$

Herein, the relationship between AV and θ is expressed by the expression: AVn=−(θn−θ0)ΔAV/Δθ+AV0. As using this expression and the equation (3), A0−An is expressed by the following equation (7).

[Equation 7]

A0−An=A0(1−2^{((θn-θ0)ΔAV/Δb}) (7)

Thus, as using the equations (6) and (7), the correction amount xsn of the cam slot 25 in the X-axis when θn is established is the following equation (8) using θ0, θn, r, R, β, θAV, and Δθ.

$$\begin{matrix}[ Equation 8 ] & \\ x s n = r ( cos θ 0 - cos θ n ) + \frac{R}{cos β} - \frac{1}{cos β} \sqrt{( {R}^{2} - \frac{Λ 0 ( 1 - {2}^{( ( {θ}_{n} - θ 0 ) Δ AV / Δ θ )} ) sin β cos β}{2}} & ( 8 )\end{matrix}$$

In order to make a cam slot which changes the Av value by an equal difference based on the number of the drive pulses of the step motor 70, the X-axis coordinate value of the virtual cam slot Y′ parallel with the Y-axis is corrected by the correction amount xsn, every Y-axis coordinate value yθn of the virtual cam slot Y′ in which the pin 52 is positioned in θn illustrated in FIG. 6C. For example, in a case where the X-axis coordinate xθn of the pin 52 in θn is greater than the target moving amount, the X coordinate value of the cam slot's position engaging with the pin 52 in θn is corrected by only the correction amount xsn corresponding to an extra moving amount, with respect to the position of the phantom cam slot Y′ parallel with the Y-axis, so as to make the cam slot closer to the rotational center C of the output member 50, as illustrating a cam slot 25A in FIG. 6A. Also, in a case where the X-axis coordinate xθn of the pin 52 in θn is smaller than the target moving amount, the X coordinate value of the cam slot's position engaging with the pin 52 in θn is corrected by only the correction amount xsn corresponding to a short moving amount, with respect to the position of the phantom cam slot Y′ parallel with the Y-axis, so as to make the cam slot distant from the rotational center C of the output member 50, as illustrating a cam slot 25B in FIG. 6A. Additionally, as for the correction amount xsn calculated by the equation (8), a positive value indicates the above extra moving amount, and a negative value indicates the above short moving amount. It is thus possible to make the cam slot changing the Av value by an equal difference in accordance with the equation (8).

In the above way, the cam slot 25 is made by correcting the phantom cam slot Y′ parallel with the Y-axis in each Av value. Therefore, whenever the output member 50 rotates by a predetermined angle, that is, whenever the step motor 70 rotates by a predetermined number of the drive pulses, the blade 20 moves to the stop position corresponding to the Av value, and this changes the Av value by an equal difference, the Av value being defined by the aperture area of the opening 11c. Additionally, the cam slot 35 also includes an end portion 35c1 and the other end portion 35c2, and the shapes of the cam slots 25 and 35 are symmetric with respect to the rotational center C. The cam slots 25 and 35 are corrected in such a way, thereby suitably ensuring the interval moving amounts of the blades 20 and 30. This improves the accuracy of the aperture.

Also, since the cam slots 25 and 35 are corrected in this way, when the output member 50 rotates counterclockwise from the state where the aperture area of the opening 11c is the minimum as illustrated in FIG. 6A, the blades 20 and 30 are moved with the pins 52 and 53 of the output member 50 engaging with the cam slots 25 and 35 of the blades 20 and 30, respectively. Therefore, the blades 20 and 30 lineally move in the opposite directions so as to change the Av value, by an equal difference, defined by every aperture area of the opening 11c, according to the number of the drive pulses of the step motor 70, that is, according to the predetermined rotational angle of the step motor 70. Herein, in the range between a position in which the output member 50 starts rotating and a position in which the pins 52 and 53 of the output member 50 reach the Y-axis, the blades 20 and 30 linearly move so as to change the Av value, by an equal difference, defined by every aperture area. However, the pins 52 and 53 of the output member 50 rotate across the Y-axis afterward, so that the pins 52 and 53 of the output member 50 respectively engage with and move the cam slots 25 and 35 of the blades 20 and 30 in the opposite directions in the Y-axis direction, enabling the blades 20 and 30 to move as illustrated in FIGS. 3C and 3D. Thus, the Av value, defined by every aperture area of the opening 11c, is not changed by an equal difference based on a predetermined rotational angle of the step motor 70. For this reason, the target moving amount for every Av value later is achieved by adjusting the number of the drive pulses of the step motor 70. In the region of the large aperture side in which the pins 52 and 53 of the output member 50 rotates across the Y-axis, the distance between the adjacent stop positions of each of the blades 20 and 30, that is, the interval moving amount is large. Thus, each moving amount of the blades 20 and 30 based on one drive pulse is sufficiently smaller than the interval moving amount. Therefore, even when the aperture area of the opening 11c is determined by adjusting the number of the drive pulses of the step motor 70, the accuracy of the aperture might not be degraded.

In such a way, each of the cam slots 25 and 35 is corrected to have a non-straight shape. However, these shapes are not complicated so that it is difficult to rotate the output member 50. This is because the angle between the X-axis and the directional line D when the aperture area of the opening 11c is the minimum is set from minus 20 degrees to plus 30 degrees as illustrated in FIG. 5. Therefore, a small correction amount of the shapes of the cam slots 25 and 35 can make the moving amounts of the blades 20 and 30 close to the target moving amounts.

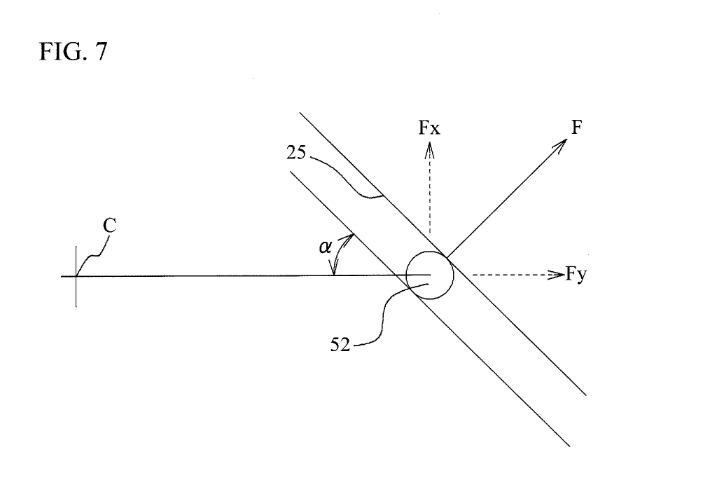

Also, in the present embodiment, as illustrated in FIG. 6A, α indicates an angle between the Y-axis and an inclination of the cam slot 25 at the position where the pin 52 of the output member 50 engages with the cam slot 25 of the blade 20. Minus 45 degrees≦α≦45 degrees is established in the whole range of the cam slot 25. Thus, the blade 20 can be driven effectively. This reason will be described with reference to FIG. 7. FIG. 7 is an explanatory view of the shape of the cam slot in the present embodiment and is an enlarged view of the engagement state of the cam slot 25 with the pin 52. In FIG. 7, F indicates the force which the pin 52 exerts on the blade 20 by the drive pulse of the step motor, Fx indicates the drive force driving the blade 20 in the X-axis direction, and Fy indicates the drive force driving the blade 20 in the Y-axis direction. Herein, the drive force Fy which drives the blade 20 in the Y-axis direction generates the friction load in such a direction as to drive the blade 20 in the X-axis direction. Thus, as for the angle α between the Y-axis and the inclination of the cam slot 25, when minus 45 degrees>α or α>45 degrees is established, the drive force Fy is greater than the drive force Fx, so that the blade 20 cannot be driven effectively. In the present embodiment, minus 45 degrees≦α≦45 degrees is established in the whole range of the cam slot 25 engaging with the pin 52. These arrangements can prevent the drive force Fx of the pin 52 driving the blade 20 in the X-axis direction from being smaller than the drive force Fy of the pin 52 driving the blade 20 in the Y-axis direction. Thus, the blade 20 can be driven effectively in the X-axis direction. Additionally, since the shape of the cam slot 35 of the blade 30 is symmetric with the shape of the cam slot 25 of the blade 20 with respect to the rotational center C, the blade 30 can be driven effectively in the X-axis direction, like the blade 20.

Additionally, the drive force of the step motor 70 is transmitted to the blades 20 and 30 through the speed reduction mechanism 80, as described above. Therefore, the output member 50 can be rotated with high torque. For example, even if the shapes of the cam slots 25 and 35 are hard for the pins 52 and 53 to respectively move therein, the pins 52 and 53 can be respectively moved within the cam slots 25 and 35 in a stable manner.

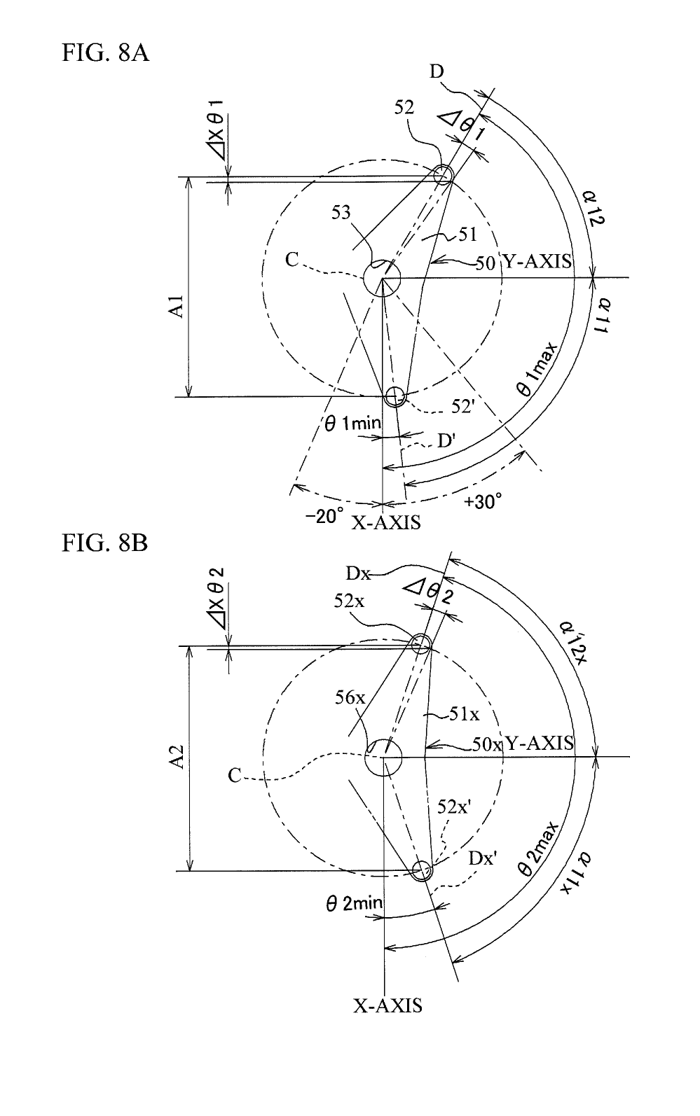

Next, the rotational angle range of the output member 50 will be described. FIGS. 8A and 8B are explanatory views of the rotational angle range of the output member 50. FIG. 8A is an explanatory view of the rotational angle range of the output member 50 of the aperture device 1 according to the present embodiment. FIG. 8B is an explanatory view of the rotational angle range of an output member 50x of an aperture device different from the present embodiment.

FIG. 8A illustrates a position of the pin 52 in the state where the aperture area of the opening 11c is the maximum and a position 52′ of the pin 52 in the state where the aperture area of the opening 11c is the minimum (hereinafter, the pin 52′ indicates the pin 52 at this position, and likewise, the pin in the minimum state is attached with [′] in the other drawings). α11 indicates an angle between the Y-axis and a directional line D′ when the aperture area of the opening 11c is the minimum. α12 indicates an angle between the Y-axis and the directional line D when the aperture area of the opening 11c is the maximum. A1 indicates a distance between the pin 52 and the pin 52′ in the X-axis direction. In the aperture device 1 according to the present embodiment, the angle α11 is set greater than the angle α12. Also, θ1min indicates an angle between the X-axis and the directional line D′ when the aperture area of the opening 11c is the minimum. θ1max indicates an angle between the X-axis and the directional line D when the aperture area of the opening 11c is the maximum. Herein, in the aperture device 1 according to the present embodiment, the angle θ1max indicating the rotational angle range of the output member 50 is set equal to or greater than 90 degrees and equal to and less than 180 degrees. Thus, as illustrated in FIG. 8A, the pin 52 of the output member 50 rotates across the Y-axis.

In FIG. 8B, α11x indicates an angle between the Y-axis and a directional line Dx′ when the aperture area of the opening 11c is the minimum. α12x indicates an angle between the Y-axis and a directional line Dx when the aperture area of the opening 11c is the maximum. FIG. 8B illustrates a position of a pin 52x in the state where the aperture area of the opening 11c is the maximum and a position 52x′ of the pin 52x in the state where the aperture area of the opening 11c is the minimum. A2 indicates a distance between the pin 52x and the pin 52x′ in the X-axis direction. Herein, in FIG. 8B, the angles α11x and α12x are set to the same angle. Also, the distance A2 between the pin 52x and the pin 52x′ in the X-axis direction is the same as the distance A1.

It is assumed that the output members 50 and 50x respectively rotate clockwise by the same angles Δθ1 and Δθ2 from the state where the aperture area of the opening 11c is the maximum. In this case, a moving amount ΔXθ1 of the pin 52 in the X-axis direction is greater than a moving amount ΔXθ2 of the pin 52x in the X-axis direction. This is because the pin 52 is closer to the Y-axis and the pin 52x is more distant from the Y-axis, that is, because the angle α11 is greater than the angle α12.

Herein, as described above, the large moving amount of the blade 20 is required, when the blade 20 is in the vicinity of the position where the aperture area of the opening 11c is the maximum. This is because the target moving amount of the blade 20 for changing the Av value, by an equal difference, defined by the aperture area of the opening 11c increases as the aperture area of the opening 11c increases.

In the present embodiment, as illustrated in FIG. 8A, the angle α11 is set greater than the angle α12. Therefore, the moving amount of the blade 20 in the X-axis direction is suppressed from decreasing when the blade 20 is in the vicinity of the position where the aperture area of the opening 11c is the maximum. Also, the target moving amount of the blade 20 increases as the blade 20 moves closer to the position where the aperture area of the opening 11c is the maximum. For this reason, in order to adapt to the target moving amount of the blade 20, the number of the drive pulses energized to the coils 73 of the step motor 70 is increased, thereby increasing the rotational angle of the rotor 75. In such a way, the target moving amount is configured to increase as the aperture area adjusted by the blade 20 increases. Thus, in the large aperture side around the position where the opening area of the opening 11c is the maximum, the number of the pulses that is necessary for driving the output member 50 of the aperture device 1 according to the present embodiment illustrated in FIG. 8A is smaller than the number of the pulses that is necessary for driving the output member 50x illustrated in FIG. 8B. As mentioned above, when the output members 50 and 50x rotate clockwise by the same angle, the moving amount ΔXθ1 of the pin 52 in the X-axis direction is greater than the moving amount ΔXθ2 of the pin 52x in the X-axis direction. Thus, when the moving amounts of the blades driven by the output members 50 and 50x are the same, the rotational angle of the output member 50 smaller than that of the output member 50x is sufficient. In the present embodiment, the angle α11 is set greater than the angle α12. Therefore, in a case where the blade 20 is frequently moved to change the aperture area in the large diameter side in which the pins 52 and 53 of the output member 50 rotate across the Y-axis, the target aperture area can be quickly formed by a reduction in the number of the pulses energized to the coils 73. Also, this can reduce the power consumption.

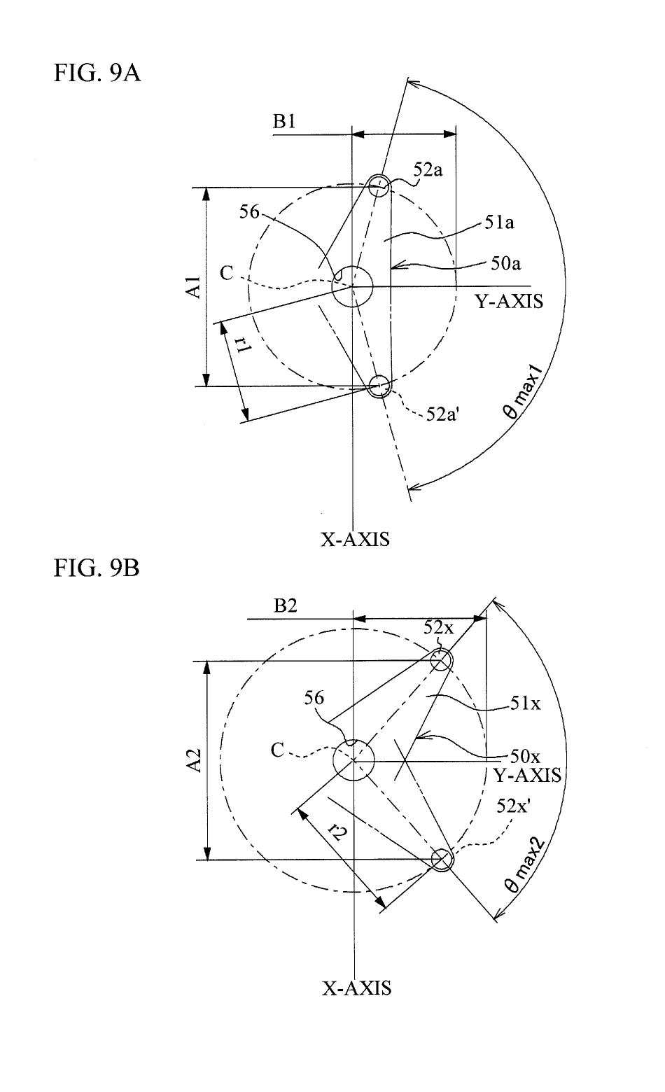

Next, a description will be given of a reduction in the size of the output member caused by the difference between the rotational angles of the output member. FIGS. 9A and 9B are explanatory views of a reduction in the size of the output member caused by the difference between the rotational angles of the output member. Additionally, FIGS. 9A and 9B illustrates an example of an output member which rotates by a rotational angle range different from that of the output member 50 employed in the aperture device 1 according to the present embodiment, in order to describe the present embodiment. FIG. 9A illustrates an output member 50a having a large rotational angle θmax1. FIG. 9B illustrates the output member 50x having a small rotational angle θmax2. The distance A1 from a pin 52a to a pin 52a′ in the X-axis direction is the same as the distance A2 from the pin 52x to a pin 52x′ in the X-axis direction. Also, the distance r1 from the rotational center C of the output member 50a to the pin 52a is smaller than the distance r2 from the rotation center C of the output member 50x to the pin 52x. Thus, in order to ensure the distance in the X-axis direction, the distance from the rotational center C to the pin 52a is made smaller as the rotational angle range of the output member is greater. Here, the moving distance in the X-axis direction influences the moving distance of the blade. Thus, the moving amount of the blade 20 can be ensured and the size of the output member 50 can be made smaller as the rotational angle range of the output member 50 is greater. In the aperture device 1 according to the present embodiment, the rotational angle range of the output member 50 is set equal to or greater than 90 degrees and equal to or less than 180 degrees from the X-axis. For this reason, the size of the output member 50 is made smaller while ensuring the moving distance of the blade 20.

Next, a galvanometer will be described. The aperture device 1 according to the present embodiment employs the step motor as the drive source, whereas an aperture device using the galvanometer is conventionally known.

The rotational angle range of a rotor of the galvanometer is generally limited to about 60 degrees. Further, a holding torque for holding the rotor at a predetermined position greatly varies according to the position thereof. The rotational angle range of the rotor in the step motor is not limited. Also, the holding torque of the rotor varies little. It is therefore possible to stop the blade in a stable manner. This improves the accuracy of the aperture.

Also, the large rotational angle of the rotor in the galvanometer is ensured by applying the large amount of the current to a coil. Also, the aperture device employing the galvanometer is controlled by the feedback control controlling the amount of the current applied to the coil in response to output signals indicating the amount of the light which an image pickup element receives. Thus, the small rotational angle range of the rotor cannot be positionally restricted in the stable manner, so the rotor might not be stopped at a predetermined position with accuracy. In a case where the amount of the current applied to the coil is controlled by the feedback control in such an above case, the actual amount of the light is smaller than the desired amount of the light, so that the amount of the current applied to the coil might be controlled to be increased. After that, the actual amount of the light might be larger than the desired amount of the light, so the amount of the current applied to the coil might be controlled to be reduced. The amount of the current applied to the coil might increase and decrease repeatedly in such a way, so the desired amount of the light might not be retained.

Also, in order to stop the rotor of the galvanometer at a predetermined position, a predetermined amount of the current has to be constantly applied to the coil. This might increase the power consumption. However, in the step motor 70, the rotor 75 can be held at a predetermined position in a non-energized state. This suppresses the power consumption.

Also, in the aperture device 1 according to the present embodiment, as illustrated in FIGS. 3A and 3B, at the small aperture side between the position where the output member 50 starts rotating and the position where the pins 52 and 53 of the output member 50 rotates across the Y-axis, the shapes of the cam slots 25 and 35 have regions which move the blades 20 and 30 to change the Av value by an equal difference, the Av value being defined by the aperture area of the opening 11c every predetermined rotational angle of the output member 50. Thus, in the aperture device 1 according to the present embodiment, the aperture area of the opening 11c can be controlled with ease, while the accuracy of the aperture is retained by the drive pulses of the step motor 70 even at the small aperture side in which the aperture area of the opening 11c is comparatively small.

As mentioned above, the rotor of the galvanometer has the comparatively small rotational angle range, whereas the rotor of the step motor has the unlimited rotational angle range. Thus, the rotational angle range of the output member 50 is set large in the aperture device 1 equipped with the step motor 70, as compared with a case where the rotor of the galvanometer is directly connected with the output member. The output member 50 of the rotational range is set large, thereby reducing the rotational range of the play with respect to the rotational range of the output member 50 corresponding to the single step rotation of the step motor 70. This relatively reduces the play of the rotational range. Thus, the positional displacement of the output member 50 can be reduced, so the positional displacement of the blades 20 and 30 can be reduced.

Also, the drive force of the step motor 70 is transmitted to the output member 50 through the speed reduction mechanism 80 as mentioned above. Herein, the rotational range of the output member 50 is set large, thereby reducing the reduction ratio of the speed reduction mechanism 80. Therefore, the number of the gears provided in the speed reduction mechanism 80 can be reduced. In a case of the large number of the gears, a problem might arise as follows.

The backlash is set between gears meshing with each other. Also, the play between a shaft of the gear and a portion supporting the shaft is provided. Such play accumulates in the gear to which the drive force is finally transmitted. The stop position of the gear to which the drive force is finally transmitted might be varied in accordance with the rotational direction by such play. Therefore, the stop position of the blade might be also varied, so the accuracy of the aperture might be degraded.

However, the rotational range of the output member 50 is set large. Thus, the reduction ratio of the speed reduction mechanism 80 can be reduced. That is, the speed reduction mechanism 80 in which the number of the gears is reduced can be employed. This reduces the play in the gear 85 to which the drive force is finally transmitted. Therefore, the stop positions of the blades 20 and 30 can be suppressed. Also, the speed reduction mechanism 80 in which the number of the gears is reduced is employed, a reduction in size and a reduction in cost are achieved.

While the preferred embodiments of the present invention have been illustrated in detail, the present invention is not limited to the above-mentioned embodiments, and other embodiments, variations and modifications may be made without departing from the scope of the present invention.

The aperture device according to the present embodiment can be employed in an optical instrument such as a still camera, a digital camera, or a surveillance camera.

In the above embodiment, the output member 50 has a lever shape. However, the output member 50 is not limited to such a shape. For example, the output member 50 may be gear meshed with the gear 85 and having the pins 52 and 53.

In the above embodiment, each of the blades 20 and 30 can stop at greater than or equal to four positions. However, each of the blades 20 and 30 have only to stop at greater than or equal to three positions.

Finally, several aspects of the present invention are summarized as follows.

According to an aspect of the present invention, there is provided an aperture device including: a board including an opening; a step motor capable of stopping every predetermined rotational angle; an output member including first and second pins and rotating a predetermined range by the step motor; and first and second blades driven by the output member with first and second blades respectively engaging with the first and second pins, linearly moving in opposite directions, and covering the opening to adjust an aperture area of the opening; wherein an X-axis indicates a phantom line passing through a rotational center of the output member and extending in the moving directions of the blades, a Y-axis indicates a phantom line passing through the rotational center of the output member and being perpendicular to the X-axis, and when the aperture area is a minimum, an angle between a directional line, which connects the rotational center with the first pin, and the X-axis is from minus 20 degrees to plus 30 degrees.

When the aperture area is the minimum, the angle between the X-axis and the directional line of the output member is from minus 20 degrees to plus 30 degrees. This makes it possible to reduces a distance between adjacent stop positions of the blade in the vicinity of a position of the blade forming the minimum aperture area. It is therefore possible to make an actual moving amount of the blade close to the target moving amount. Thus, the accuracy of the aperture is improved.

According to another aspect of the present invention, there is provided an optical instrument having the above aperture device.

What is claimed is:

1. An aperture device comprising:
a board including an opening;
a step motor capable of stopping every predetermined rotational angle;
an output member including first and second pins and rotating a predetermined range by the step motor; and
first and second blades driven by the output member with first and second blades respectively engaging with the first and second pins, linearly moving in opposite directions, and covering the opening to adjust an aperture area of the opening;
wherein an X-axis indicates a phantom line passing through a rotational center of the output member and extending in the moving directions of the blades,
a Y-axis indicates a phantom line passing through the rotational center of the output member and being perpendicular to the X-axis, and
when the aperture area is a minimum, an angle between a directional line, which connects the rotational center with the first pin, and the X-axis is from minus 20 degrees to plus 30 degrees.

2. The aperture device of claim 1, wherein
α11 indicates an angle between the directional line and the Y-axis when the aperture area is the minimum,
α12 indicates an angle between the directional line and the Y-axis when the aperture area is a maximum, and
α11 is greater than α12.

3. The aperture device of claim 1, wherein the output member is capable of stopping at plural positions in a range between a position where the aperture area is the maximum and a position where the aperture area is the minimum.

4. The aperture device of claim 1, wherein
an angle of a rotational range of the output member, expressed by an angle between the X-axis and the directional line when the aperture area is the maximum, is equal to or greater than 90 degrees and equal to or less than 180 degrees, and
the first and second pins of the output member rotate across the Y-axis.

5. The aperture device of claim 1, wherein
the first and second blades include first and second cam slots engaging with the first and second pins, respectively, and
shapes of the first and second cam slots respectively include regions which respectively move the first and second blades to change an Av value by an equal difference, the Av value being defined by the aperture area every predetermined rotational angle of the output member between a position where the aperture area is the minimum to a position where the aperture area is the maximum.

6. The aperture device of claim 1, wherein
the first and the second blades overlap each other to form an aperture shape having a diamond shape,
opposite angle portions of the diamond shape on the X-axis have arc shapes, respectively,
opposite sides of the diamond shape extend in tangential directions of each of the arc shapes, respectively,
a cutout is provided in one of the first and second blades and defines one of pairs of the arc shape and the opposite sides,
an aperture opening is provided in the other one of the first and second blades and defines the other one of pairs of the arch shape and the opposite sides,
the first and second blades include first and second cam slots engaging with the first and second pins, respectively,
the shapes of the first and second cam slots are symmetrical with respect to the rotational center of the output member, and include regions which respectively move the first and second blades to change an Av value by an equal difference, the Av value being defined by the aperture area every predetermined rotational angle of the output member, in the regions, and
each of the shapes of the first and second cam slots is made by correcting a portion of a phantom cam slot parallel with the Y-axis by an correction amount xsn in the X-axis direction, the portions being in which the first and second pins are positioned when an angle θn is defined between the X-axis and a line connecting the rotational center of the output member with the first and second pins, respectively, and
the correction amount xsn satisfies a following expression of a first equation,
$$x s n = r ( cos θ 0 - cos θ n ) + \frac{R}{cos β} - \frac{1}{cos β} \sqrt{( {R}^{2} - \frac{A 0 ( 1 - {2}^{( ( θ n - θ 0 ) Δ AV / Δ θ )} ) sin β cos β}{2} )} \qquad [ Equation 1 ]$$
where r stands for a distance between the rotational center and each of the first and second pins,
θ0 stands for an angle between the X-axis and the directional line connecting the rotational center of the output member with the first and second pins when the aperture area is the minimum,
θn stands for an angle between the X-axis and the directional line connecting the rotational center of the output member with the first and second pins after the output member rotates in such a direction as to increase the aperture area from the minimum of the aperture area such that the Av value is changed by n steps,
R stands for a radius of the arc of the aperture shape,
β stands for an interior angle, between the opposite sides of the aperture shape located in the Y-axis direction, divided by two,
ΔAV stands for an amount of a change per the step,
Δ0 stands for a predetermined rotational angle of the output member per the step, and
A0 stands for the minimum of the aperture area.

7. The aperture device of claim 1, wherein
there is a region where the Av value defined by the aperture area changes by an equal difference every predetermined rotational angle of the output member, and
the region is between a position where the aperture area is the minimum and a position where the output member starts rotating to reach the Y-axis.

8. The aperture device of claim 1, wherein
the first and second blades include first and second cam slots engaging with the first and second pins, respectively,
minus 45 degrees≦α≦45 degrees is satisfied, where an angle α is defined between the Y-axis and each of the first and second cams at the position where the first and second pins respectively engage with the first and second cam slots.

9. The aperture device of claim 1, further comprising a reduction gear reduces a speed of rotational force of the step motor and transmits the rotational force to the output member.

10. The aperture device of claim 1, wherein the rotational center overlaps at least part of the first and second blades in moving ranges of the first and second blades.

11. An optical instrument comprising the aperture device of claim 1.
